(19) United States
(12) Patent Application Publication
(10) Pub. No.: US 2025/0080414 A1
(43) Pub. Date: Mar. 6, 2025

(54) SERVICE INSERTION AT LOGICAL NETWORK GATEWAY

(71) Applicant: VMware LLC, Palo Alto, CA (US)

(72) Inventors: Akhila Naveen, Palo Alto, CA (US); Kantesh Mundaragi, Bangalore (IN); Rahul Mishra, Mountain View, CA (US); Fenil Kavathia, Sunnyvale, CA (US); Raju Koganty, San Jose, CA (US); Pierluigi Rolando, Santa Clara, CA (US); Yong Feng, Sunnyvale, CA (US); Jayant Jain, Cupertino, CA (US)

(21) Appl. No.: 18/952,462

(22) Filed: Nov. 19, 2024

Related U.S. Application Data
(63) Continuation of application No. 18/102,684, filed on Jan. 28, 2023, now Pat. No. 12,177,067.
Application No. 18/102,684 is a continuation of application No. 16/120,283, filed on Sep. 2, 2018, now Pat. No. 11,595,250.

(51) Int. Cl. H04L 41/0806; H04L 12/66; H04L 45/42; H04L 49/35; H04L 67/53

(52) U.S. Cl. CPC H04L 41/0806; H04L 12/66; H04L 45/42; H04L 49/355; H04L 67/53

(57) ABSTRACT

Some embodiments provide a method for configuring a gateway machine in a datacenter. The method receives a definition of a logical network for implementation in the datacenter. The logical network includes at least one logical switch to which logical network endpoints attach and a logical router for handling data traffic between the logical network endpoints in the datacenter and an external network. The method receives configuration data attaching a third-party service to at least one interface of the logical router via an additional logical switch designated for service attachments. The third-party service is for performing non-forwarding processing on the data traffic between the logical network endpoints and the external network. The method configures the gateway machine in the datacenter to implement the logical router and redirect at least a subset of the data traffic between the logical network endpoints and the external network to the attached third-party service.

### CLAIM OF BENEFIT TO PRIOR APPLICATIONS

The present application is a continuation of U.S. patent application Ser. No. 18/102,684, filed Jan. 28, 2023. U.S. patent application Ser. No. 18/102,684 is a continuation of U.S. patent application Ser. No. 16/120,283, filed Sep. 2, 2018, now issued as U.S. Pat. No. 11,595,250. These patent applications and patents are incorporated herein by reference in their entireties for all purposes.

### BACKGROUND

Many corporations and other entities use software-defined datacenters (e.g., on-premises datacenters and/or public cloud datacenters) to host their networks. The providers of the software-defined datacenters typically provide various network security options, but some entities will want to incorporate existing third-party security services (or other services) into their hosted networks. Thus, techniques for more easily incorporating such services into virtual networks would be useful.

### BRIEF SUMMARY

Some embodiments provide a network management and control system that enables integration of third-party service machines for processing data traffic entering and/or exiting a logical network. These third-party services may include various types of non-packet-forwarding services, such as firewalls, virtual private network (VPN) service, network address translation (NAT), load balancing, etc. In some embodiments, the network management and control system manages the integration of these service machines, but does not manage the life cycle of the machines themselves.

In some embodiments, the logical network includes at least one logical switch to which logical network endpoints (e.g., data compute nodes such as virtual machines, containers, etc.) connect as well as a logical router for handling data traffic entering and/or exiting the logical network. In addition, the logical network may include multiple logical switches that logically connect to each other through either the aforementioned logical router or another logical router. In some embodiments, the logical network includes multiple tiers of logical routers. Logical routers in a first tier connect groups of logical switches (e.g., the logical switches of a particular tenant). These first-tier logical routers connect to logical routers in a second tier for data traffic sent to and from the logical network (e.g., data traffic from external clients connecting to web servers hosted in the logical network, etc.). The second-tier logical routers are implemented at least partly in a centralized manner for handling the connections to the external networks, and in some embodiments the third-party service machines attach to the centralized components of these logical routers. The logical networks of other embodiments include only a single tier of logical routers, to which the third-party services attach.

In some embodiments, the network management and control system (referred to subsequently as a network control system) receives both (i) configuration data defining the logical network (i.e., the logical switches, attachment of data compute nodes to the logical switches, logical routers, etc.) as well as (ii) configuration data attaching a third-party service to a logical router (i.e., the logical router that handles connections to external networks). Based on this configuration data, the network control system configures various managed forwarding elements to implement the logical forwarding elements (the logical switches, distributed aspects of the logical routers, etc.) as well as other packet processing operations for the logical network (e.g., distributed firewall rules). In addition, some embodiments configure a particular managed forwarding element operating on a gateway machine to implement a centralized logical routing component that handles the connection of the logical network to one or more external networks. This managed forwarding element on the gateway machine is also configured to redirect (e.g., using policy-based routing) at least a subset of this ingress and/or egress data traffic between the logical network and the external networks to the attached third-party service via a separate interface of the gateway.

In some embodiments, receiving the configuration data to attach the third-party service includes several separate configuration inputs (e.g., from an administrator). After the logical router is configured, some embodiments receive configuration data (i) defining a service attachment interface for the logical router, (ii) defining a logical switch to which the service attachment interface connects, (iii) defining the service interface (e.g., the interface of the service machine to which data traffic is redirected), and (iv) connecting the service attachment interface of the logical router and the service interface to the logical switch. In addition, in some embodiments, the administrator defines a rule or set of rules specifying which ingress and/or egress traffic is redirected to the service interface.

Some embodiments enable multiple services to be connected to the logical router, using various different topologies. For instance, multiple services may be connected to the same logical switch, in which case these services all have interfaces in the same subnet and can send data traffic directly between each other if configured to do so. In this setup, the logical router can have a single interface that connects to the logical switch (for traffic to all of the services) or a separate interface connected to the logical switch for each attached service. In other cases, separate logical switches can be defined for each service (with separate logical router interfaces connected to each of the logical switches). In addition, multiple interfaces can be defined for each service machine, for handling different sets of traffic (e.g., traffic to/from different external networks or different logical network subnets).

In addition, the service machines may be connected to the logical router via different types of connections in some embodiments. Specifically, some embodiments allow for service machines to be connected in either (i) an L2 bump-in-the-wire mode or (ii) a L3 one-arm mode. In the L2 mode, two interfaces of the logical router are connected to two separate interfaces of the service machine via two separate logical switches, and data traffic sent to the service machine via one of the interfaces and received back from the service machine via the other interface. Data traffic may be sent to the service machine via one interface for traffic entering the logical network and via the other interface for traffic exiting the logical network. In the L3 mode, a single interface is used on the logical router for each connection with the service machine.

Once configured, the gateway redirects some or all of the data traffic between the logical network and external networks to the service machine. As mentioned, some embodiments use a set of policy-based routing (PBR) rules to determine whether or not to redirect each data message. In some embodiments, the gateway applies these PBR rules to outgoing data messages after performing logical routing for the data messages, and applies the PBR rules to incoming data messages prior to performing logical routing and/or switching for incoming data messages.

That is, for an outgoing data message, the gateway performs logical switching (if required), then logical routing for the routing component that connects to the external network to determine that the data message is in fact directed outside of the logical network, then applies the PBR rules to determine whether to redirect the data message to a service. If the data message is redirected, then upon its return from the service (if the data message is not dropped/blocked by the service) the gateway forwards the data message to the external network.

For an incoming data message, the gateway applies the PBR rules to determine whether to redirect the data message to a service before processing the data message through any of the logical forwarding elements. If the data message is redirected, then upon its return from the service (if the data message is not dropped/blocked by the service) the gateway then performs logical routing and switching, etc. to the data message to determine how to forward the data message to the logical network.

In some embodiments, the PBR rules use a two-stage lookup to determine whether to redirect a data message (and to which interface to redirect the data message). Specifically, rather than the PBR rules (i.e., routing rules based on header fields other than destination network address) providing the redirection details, each rule specifies a unique identifier. Each identifier corresponds to a service machine, and the gateway stores a dynamically-updated data structure for each identifier. These data structures, in some embodiments, indicate the type of connection to the service (e.g., L2 bump-in-the-wire or L3 one-arm), a network address for the interface of the service to which the data message is redirected (for L2 mode, some embodiments use a dummy network address that corresponds to the data link layer address of the return service attachment interface of the gateway), dynamically-updated status data, and a failover policy. The status data is dynamically updated based on the health/reachability of the service, which may be tested using a heartbeat protocol such as bidirectional forwarding detection (BFD). The failover policy, in some embodiments, specifies what to do with the data message if the service is not reachable. These failover policy options may include, e.g., drop the data message, forward the data message to its destination without redirection to the service, redirect to a backup service machine, etc.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawing, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates an example logical network of some embodiments to which third-party services can be connected.

FIG. 2 conceptually illustrates an example of connecting a third-party service machine to a centralized router.

FIG. 3 conceptually illustrates a process of some embodiments for configuring a gateway machine of a logical network to redirect ingress and/or egress data traffic to a third-party service machine.

FIG. 4 conceptually illustrates a centralized routing component with two service attachment interfaces that connect to two separate service endpoint interfaces of a third-party service machine via two separate logical switches.

FIG. 5 conceptually illustrates a centralized routing component with one service attachment interface that connects to two separate interfaces of a third-party service machine via one logical switch.

FIG. 6 conceptually illustrates a centralized routing component with one service attachment interface that connects to interfaces of two different third-party service machines via one logical switch.

FIG. 7 conceptually illustrates a centralized routing component with two service attachment interfaces that each connect to a different service machine of two service machines via separate logical switches.

FIG. 8 illustrates the path of an ingress data message through multiple stages of logical processing implemented by a gateway managed forwarding element and a third-party service machine connected in L3 one-arm mode.

FIG. 9 illustrates the path of an egress data message through the multiple stages of logical processing implemented by the gateway MFE and the third-party service machine of FIG. 8.

FIG. 10 illustrates the path of an ingress data message through multiple stages of logical processing implemented by a gateway MFE and a third-party service machine connected in L2 bump-in-the-wire mode.

FIG. 11 illustrates the path of an egress data message through the multiple stages of logical processing implemented by the gateway MFE and the third-party service machine of FIG. 10.

FIG. 12 conceptually illustrates a process of some embodiments for applying policy-based routing redirection rules to a data message.

FIG. 13 illustrates a table of policy-based routing rules.

FIG. 14 conceptually illustrates the data structure being dynamically updated based on a change in the connection status of the service machine to which the data structure redirects data messages.

FIG. 15 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a network management and control system that enables integration of third-party service machines for processing data traffic entering and/or exiting a logical network. These third-party services may include various types of non-packet-forwarding services, such as firewalls, virtual private network (VPN) service, network address translation (NAT), load balancing, etc. In some embodiments, the network management and control system manages the integration of these service machines, but does not manage the life cycle of the machines themselves (hence referring to these service machines as third-party services).

In some embodiments, the logical network includes at least one logical switch to which logical network endpoints (e.g., data compute nodes such as virtual machines, containers, etc.) connect as well as a logical router for handling data traffic entering and/or exiting the logical network. In addition, the logical network may include multiple logical switches that logically connect to each other through either the aforementioned logical router or another logical router.

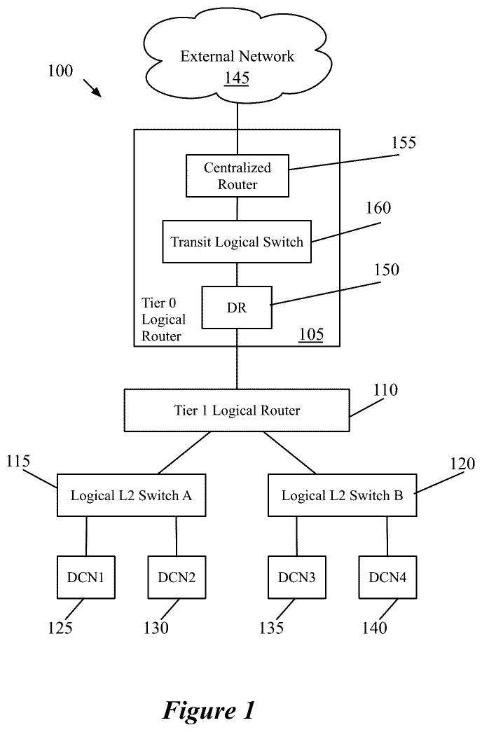

FIG. 1 conceptually illustrates an example logical network 100 of some embodiments, to which third-party services can be connected. As shown, this logical network 100 includes a tier-0 logical router 105 (also referred to as a provider logical router), a tier-1 logical router 110 (also referred to as a tenant logical router), and two logical switches 115 and 120. Data compute nodes (DCNs) 125-140 (e.g., virtual machines, containers, etc.) are attached to each of the logical switches 115 and 120. These data compute nodes 125 exchange data messages with each other and with one or more external networks 145 through a physical network that implements this logical network (e.g., within a datacenter).

The logical network 100 represents an abstraction of a network as configured by a user of the network management and control system of some embodiments. That is, in some embodiments, a network administrator configures the logical network 100 as a conceptual set of logical switches, routers, etc., with policies applied to these logical forwarding elements. The network management and control system generates configuration data for physical managed forwarding elements (e.g., software virtual switches operating in the virtualization software of host machines, virtual machines and/or bare metal machines operating as logical network gateways, etc.) to implement these logical forwarding elements. For instance, when a DCN 125-140 hosted on a physical host machine sends a data message, in some embodiments a managed forwarding element executing in the virtualization software of the host machine processes the data message to implement the logical network. The managed forwarding element would apply the logical switch configuration for the logical switch to which the DCN attaches, then the tier-1 logical router configuration, etc. to determine the destination of the data message.

In some embodiments, as in this example, the logical network includes multiple tiers of logical routers. Logical routers in a first tier (e.g., the tier-1 logical router 110) connect groups of logical switches (e.g., the logical switches of a particular tenant). These first-tier logical routers connect to logical routers in a second tier (e.g., the tier-0 logical router 105) for data traffic sent to and from the logical network (e.g., data traffic from external clients connecting to web servers hosted in the logical network, etc.).

The network management and control system of some embodiments (referred to subsequently as a network control system) defines multiple routing components for at least some of the logical routers. Specifically, the tier-0 logical router 105 in this example has a distributed routing component 150 (“distributed router”) and a centralized routing component 155, which are connected by an internal logical switch 160 referred to as a transit logical switch. In some cases, multiple centralized routers are defined for a tier-0 logical router, each of which connects to the transit logical switch 160. For instance, some embodiments define two centralized routers, one active and one standby.

In some embodiments, the distributed router 150 and the transit logical switch 160 are implemented in a distributed manner (as with the logical switches 115 and 120, and the tier-1 logical router 110), meaning that the first-hop managed forwarding element for a data message applies the policies of those logical forwarding elements to the data message. The centralized router 155, however, is implemented in a centralized manner (i.e., a single host machine implements each such centralized router). These centralized routers handle the connections of the logical network to external networks (e.g., to other logical networks implemented at the same or other datacenters, to external web clients, etc.). The centralized router may perform various stateful services (e.g., network address translation, load balancing, etc.) as well as exchange routes with one or more external routers (using, e.g., BGP or OSPF). Different embodiments may implement the centralized router using a bare metal machine, a virtual machine, a virtual switch executing in virtualization software of a host machine, or other contexts.

As mentioned, some embodiments allow the administrator to use the network control system to attach third-party services to the logical routers. In some such embodiments, these third-party services are attached to centralized routers that handle data traffic between logical network endpoints and external networks (e.g., the centralized router 155 of a tier-0 router). While the subsequent discussion primarily relates to connection of the third-party services to tier-0 logical routers, in some embodiments the third-party services may also be connected to tier-1 logical routers.

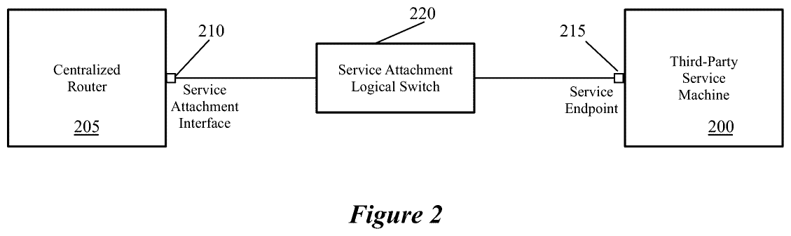

FIG. 2 conceptually illustrates an example of connecting a third-party service machine 200 to a centralized router 205. Specifically, in some embodiments, a network administrator defines a service attachment interface 210 on the logical router, a service endpoint 215 for the third-party service machine, a specific logical switch 220 for the service attachment, and attaches both the service attachment interface 210 and the service endpoint 215 to the logical switch 220. In some embodiments, an administrator provides this information through application programming interfaces (APIs) of a management plane of the network control system (e.g., using a network management application user interface that translates user interactions into API calls to the management plane).

In some embodiments, the management plane receives both (i) configuration data defining the logical network (i.e., the logical switches, attachment of data compute nodes to the logical switches, logical routers, etc.) as well as the configuration data attaching one or more third-party services to the logical router that handles connections of the logical network to external networks. Based on this configuration data, the network control system configures various managed forwarding elements to implement the logical forwarding elements (the logical switches, distributed aspects of the logical routers, etc.) as well as other packet processing operations for the logical network (e.g., distributed firewall rules). In some embodiments, the management plane generates configuration data based on the inputs and provides this configuration data to a central control plane (e.g., a set of centralized controllers). The central control plane identifies the managed forwarding elements that require each atomic piece of configuration data, and distributes the configuration data to local controllers for each identified managed forwarding element. These local controllers are then responsible for configuring the managed forwarding elements (including the gateway machine that implements the centralized router) to implement the logical forwarding elements of the logical network, including redirecting appropriate data messages to the third-party services (e.g., according to policy-based routing rules provided by the administrator).

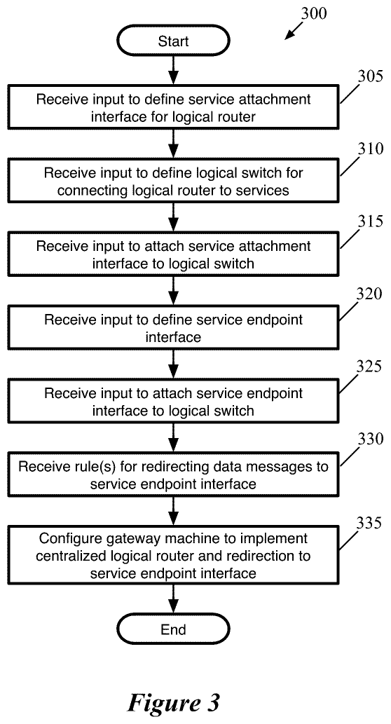

In some embodiments, receiving the configuration data to attach the third-party service includes several separate configuration inputs (e.g., from an administrator). FIG. 3 conceptually illustrates a process 300 of some embodiments for configuring a gateway machine of a logical network to redirect ingress and/or egress data traffic to a third-party service machine. In some embodiments, the process 300 is performed by the management plane of a network control system, which receives input through API calls.

In the description of this process, it is assumed that a logical network has already been configured, and that this logical network includes a logical router with at least one centralized component configured to handle data traffic entering and exiting the logical network. Some embodiments configure particular managed forwarding elements operating on gateway machines to implement these centralized logical routing components that handle the connection of the logical network to one or more external networks.

As shown, the process 300 begins by receiving (at 305) input to define a service attachment interface for a logical router. In some embodiments, a service attachment interface is a specialized type of interface for the logical router. In different embodiments, the administrator either defines this service attachment interface on a particular centralized component or on the logical router generally. In the latter case, the management plane either applies the interface to a specific one of the components (e.g., if the administrator defines that the service attachment interface will only handle traffic sent to or from a particular uplink interface of the logical router that is assigned to a particular centralized component) or creates separate interfaces for each of the centralized components of the logical router. For instance, in some embodiments, active and standby centralized routing components are defined, and interfaces are created on each of these components.

Next, the process 300 receives (at 310) input to define a logical switch for connecting the logical router to third-party services. In addition, the process receives (at 315) input to attach the service attachment interface to this logical switch. In some embodiments, this logical switch is created similarly to the logical switches of the logical network, to which data compute nodes (e.g., VMs, etc.) attach. In other embodiments, the logical switch is defined by the administrator as a specific service attachment logical switch. This logical switch has a privately allocated subnet that (i) includes the network address of the service attachment interface that is attached to the logical switch and (ii) only needs to include enough network addresses for any interfaces of third-party services and any service attachment interfaces that connect to the logical switch. For instance, as shown below, using Classless Inter-Domain Routing (CIDR) notation, a logical switch that connects a single logical router interface to a single third-party service interface could be a “/31” subnet. Even if the logical router performs route advertisement to external physical routers (e.g., using BGP or OSPF) for logical network subnets, the subnets for the service attachment logical switches are not advertised (or entered into the routing tables for the various logical router tiers) in some embodiments.

In some embodiments, if the logical router includes multiple centralized components (e.g., active and standby components) and a service attachment interface corresponds to interfaces on each of these components, then attaching the service attachment interface actually attaches each of these interfaces to the logical switch. In this case, each of the centralized component interfaces has a separate network address in the subnet of the logical switch.

Next, the process 300 receives (at 320) input to define a service endpoint interface, and receives (at 325) input to attach this service endpoint interface to the logical switch (to which the service attachment interface of the logical router is attached). In some embodiments, this service endpoint interface represents an interface on a third-party service machine. In some embodiments, when an administrator defines an endpoint interface to which a centralized routing component will connect, these interfaces can either be service endpoint interfaces (also referred to as logical endpoint interfaces, that correspond to service machines and connect to service attachment interfaces through a logical switch) or external interfaces (also referred to as virtual endpoint interfaces, which correspond to network addresses reachable from the centralized component. External router interfaces are examples of these latter interfaces.

In addition, some embodiments require the administrator to define the third-party service machine (either through the network control system or through a separate datacenter compute manager). For example, in some embodiments the network administrator defines both a service type as well as a service instance (e.g., an instance of that service type). As noted above, the service endpoint interface should also have a network address within the subnet of the logical switch to which that interface is attached.

It should be understood that operations 305-325 need not occur in the specific order shown in FIG. 3. For instance, a network administrator could initially create both of the interfaces (the service attachment interface on the logical router as well as the service endpoint interface representing the third-party service), then subsequently create the logical switch and attach the interfaces to this logical switch.

In addition, the process 300 receives (at 330) one or more rules for redirecting data messages to the service endpoint interface. In some embodiments, these are policy-based routing rules that (i) specify which ingress and/or egress traffic will be redirected to the service interface and (ii) are applied by the gateway machine separately from its usual routing operations. In some embodiments, the administrator defines the redirection rules in terms of one or more data message header fields, such as the source and/or destination network addresses, source and/or destination transport layer ports, transport protocol, interface on which a data message is received, etc. For each service interface, an administrator may create one redirection rule or multiple rules. For instance, the redirected data messages could include all incoming and/or outgoing data messages for a particular uplink, only data messages sent from or to a specific logical switch subnet, etc.

Finally, after receiving the above-described configuration data, the process 300 configures (at 335) the gateway machine to implement the centralized logical router and the redirection to the service endpoint interface. The process 300 then ends. If multiple centralized routing components have interfaces attached to the logical switch for the service endpoint, then the gateway machine for each of these components is configured. In some embodiments, the management plane generates configuration data for the service attachment interface and the redirection rules and provides this information to the central control plane. The central control plane identifies each gateway machine that requires the information and provides the appropriate configuration data to the local controller for that gateway machine. The local controller of some embodiments converts this configuration data to a format readable by the gateway machine (if it is not already in such a format) and directly configures the gateway machine to implement the policy-based routing rules.

Some embodiments enable multiple services to be connected to the logical router, using various different topologies. For instance, multiple services may be connected to the same logical switch, in which case these services all have interfaces in the same subnet and can send data traffic directly between each other if configured to do so. In this setup, the logical router can have a single interface that connects to the logical switch (for traffic to all of the services) or a separate interface connected to the logical switch for each attached service. In other cases, separate logical switches can be defined for each service (with separate logical router interfaces connected to each of the logical switches). In addition, multiple interfaces can be defined for each service machine, for handling different sets of traffic (e.g., traffic to/from different external networks or different logical network subnets).

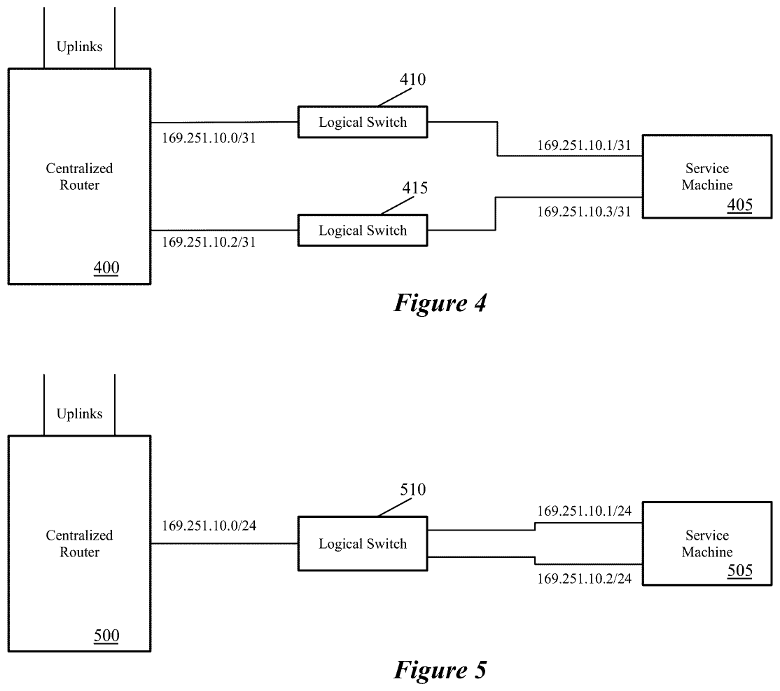

FIGS. 4-7 conceptually illustrate several different such topologies for connecting a centralized routing component of a logical router to one or more service machines. Each of these figures illustrates one centralized router connected to one or more logical switches to which one or more service machines are also connected. It should be understood that these figures represent a logical view of the connections, and that the gateway machine implementing the centralized router would also implement the logical switch(es) in some embodiments.

FIG. 4 conceptually illustrates a centralized routing component 400 with two service attachment interfaces that connect to two separate service endpoint interfaces of a third-party service machine 405 via two separate logical switches 410 and 415. This topology essentially uses a separate service attachment interface and separate logical switch for each connection to the third-party service. In this example, each of the logical switches 410 and 415 is assigned a “/31” subnet, which includes two network addresses. Because each of the logical switches is specifically created for connecting one service attachment interface of the centralized routing component 400 to the service machine 405, only two addresses are needed for each switch. In some embodiments, the redirection rules for the router redirect data messages sent to and from each of the uplinks to a different interface of the third-party service machine (and thus use a different one of the service attachment interfaces).

FIG. 5 conceptually illustrates a centralized routing component 500 with one service attachment interface that connects to two separate interfaces of a third-party service machine 505 via one logical switch 510. In some embodiments, the administrator creates one logical switch for each third-party service machine with one service attachment interface on the centralized router component, but defines multiple service endpoint interfaces for that third-party service machine. In this case, the logical switch subnet accommodates a larger number of network addresses (in the present example, a “/24” subnet is used). In some embodiments, the redirection rules are set up to redirect data messages sent to and from each of the uplinks to a different interface of the third-party service machine via the same service attachment interface and logical switch. In some embodiments, using a setup with multiple service endpoint interfaces on the service machine that attach to the same logical switch requires that the third-party service machine use separate routing tables (e.g., virtual routing and forwarding instances) for each interface.

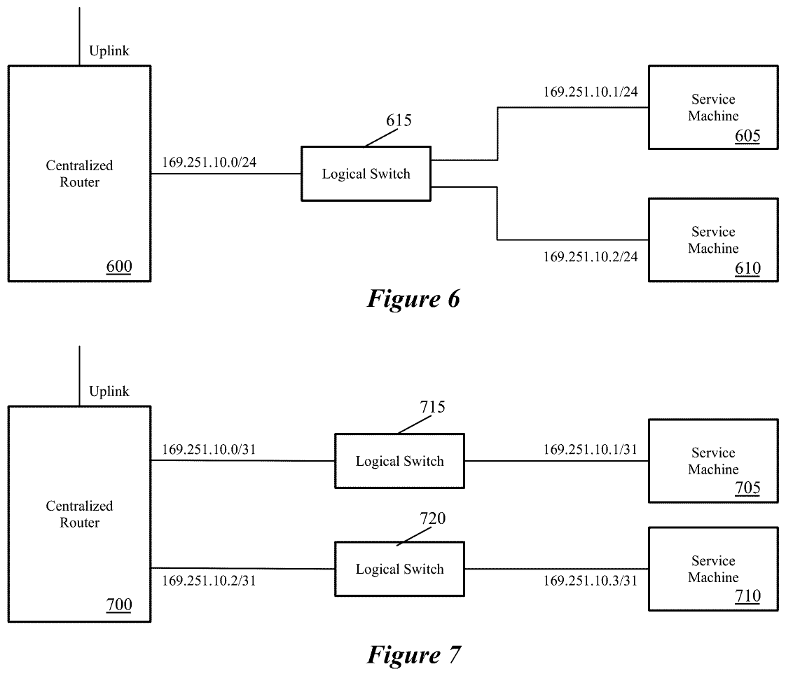

FIG. 6 conceptually illustrates a centralized routing component 600 with one service attachment interface that connects to interfaces of two different third-party service machines 605 and 610 via one logical switch 615. The service machines 605 and 610 in this scenario could provide two separate services (e.g., a firewall and a cloud extension service) or be master and standby machines for a single high-availability service. In some embodiments, because the interfaces of the service machines 605 and 610 are on the same logical switch, data messages can also be sent from one service to the other. In this example, the centralized routing component 600 has a single uplink; some embodiments using this configuration would include two service attachments and two logical switches that each connect to (different) interfaces of both service machines to handle data messages received or destined for two different uplinks.

FIG. 7 conceptually illustrates a centralized routing component 700 with two service attachment interfaces that each connect to a different service machine of two service machines 705 and 710 via separate logical switches 715 and 720. As in the previous example, these two service machines could provide two separate services or be master and standby machines for a single high-availability service. In this example, the centralized routing component has a single uplink; some embodiment using this configuration would include two additional service attachments corresponding to each additional uplink that connect via separate logical switches to separate interfaces on each of the service machines. In these examples, using separate interfaces on the service machines corresponding to each different uplink allows the service machines to apply specific processing configurations to data messages sent to or received from each different uplink.

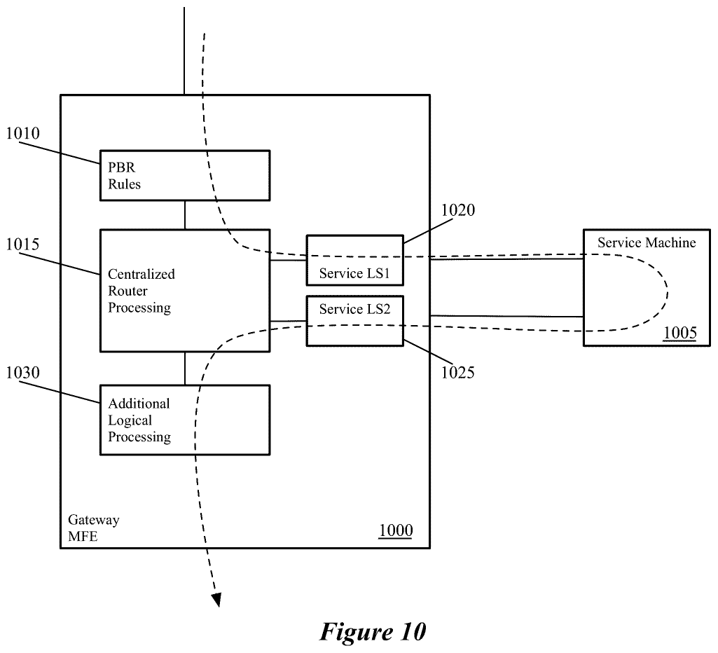

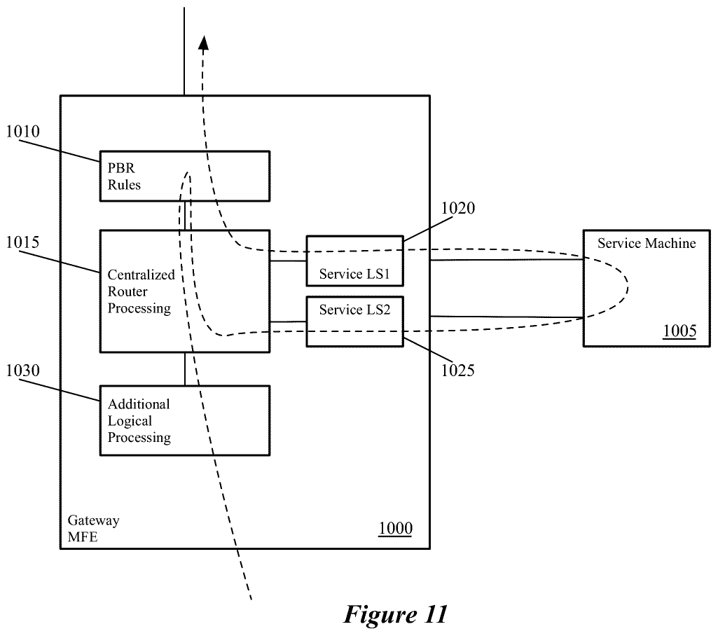

In addition to these various different topologies, the third-party service machines may be connected to the centralized routing component via different types of connections in some embodiments. Specifically, some embodiments allow for service machines to be connected in either (i) an L2 bump-in-the-wire mode or (ii) a L3 one-arm mode. In the L2 mode, shown in FIGS. 10 and 11, two interfaces of the logical router are connected to two separate interfaces of the service machine via two separate logical switches, and data traffic sent to the service machine via one of the interfaces and received back from the service machine via the other interface. Data traffic may be sent to the service machine via one interface for traffic entering the logical network and via the other interface for traffic exiting the logical network.

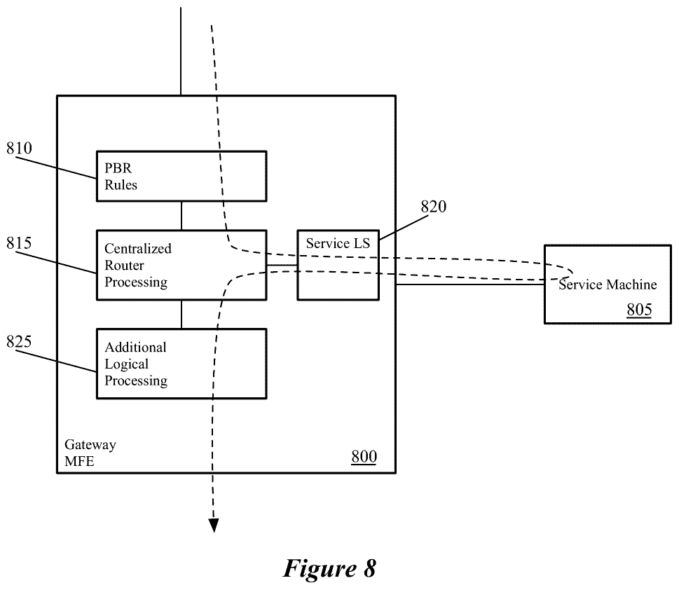

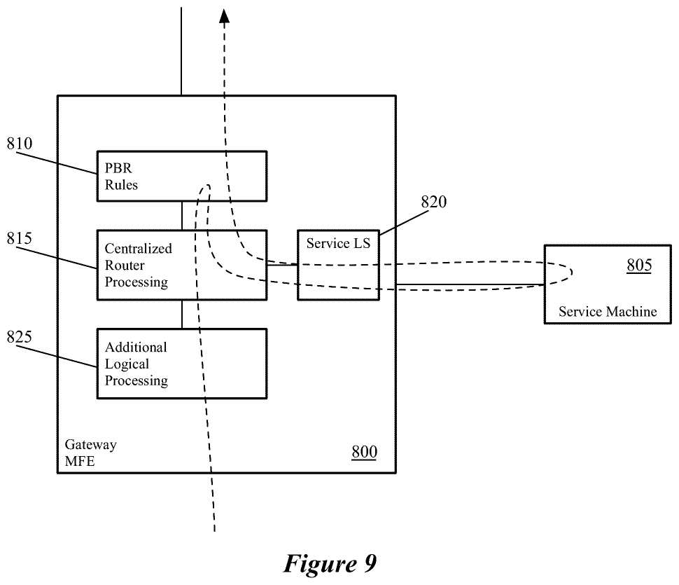

In the L3 mode, shown in FIGS. 8 and 9, a single interface is used on the logical router for each connection with the service machine. Once configured, the gateway redirects some or all of the data traffic between the logical network and external networks to the service machine. As mentioned, some embodiments use a set of policy-based routing (PBR) rules to determine whether or not to redirect each data message. In some embodiments, the gateway applies these PBR rules to outgoing data messages after performing logical routing for the data messages, and applies the PBR rules to incoming data messages prior to performing logical routing and/or switching for incoming data messages.

FIG. 8 illustrates the path of an ingress data message (represented by the dashed line) through multiple stages of logical processing implemented by a gateway managed forwarding element 800 and a third-party service machine 805. As mentioned, in this example, the third-party service machine is connected in an L3 one-arm mode. In this mode, data messages are transmitted to the network address of the third-party service machine, which transmits the data messages back to the network address of the logical router service attachment interface.

The gateway MFE 800 implements several stages of logical network processing, including policy-based routing (PBR) redirection rules 810, centralized routing component processing 815, the service attachment logical switch processing 820, and additional logical processing 825 (e.g., transit logical switch processing, distributed routing component processing, processing for other tiers of logical routers and/or logical switches to which network endpoints connect, etc. In some embodiments, the gateway MFE 800 is a datapath in a bare metal computer or a virtual machine (e.g., a data plane development kit (DPDK)-based datapath). The gateway MFE of other embodiments executes a datapath in virtualization software of a host machine. Yet other embodiments implement a portion of the logical processing in such a datapath while implementing the centralized routing component in a virtual machine, namespace, or similar construct.

For the incoming data message in FIG. 8, the gateway MFE 800 applies the PBR rules 810 to determine whether to redirect the data message before processing the data message through any of the logical forwarding elements. In some embodiments, the gateway MFE also performs additional operations before applying the PBR rules, such as IPSec and/or other locally-applied services. The PBR rules, described in further detail below, identify whether a given data message will be redirected (e.g., based on various data message header fields, such as the source and/or destination IP addresses), how to redirect the data messages that match specific sets of header field values, etc. In this case, the PBR rules 810 specify to redirect the data message to the interface of the third-party service machine 805.

Based on this determination, the centralized routing component processing 815 identifies that the redirection interface corresponds to the service attachment logical switch, so the gateway MFE 800 then executes this logical switch processing 820. Based on this logical switch processing, the gateway MFE transmits the data message (e.g., with encapsulation) to the third-party service machine 805. This service machine 805 performs its service processing (e.g., firewall, NAT, cloud extension, etc.) and returns the data message to the gateway MFE (unless the service drops/blocks the data message). Upon return of the data message from the service, the gateway MFE then performs the centralized routing component processing 815 (e.g., routing based on the destination network address) and, in turn, the additional logical processing operations 825. In some embodiments, data messages returning from the third-party service machine are marked with a flag to indicate that the PBR rules do not need to be applied again. Based on these operations, the gateway MFE 800 transmits the data message to its destination in the logical network (e.g., by encapsulating the data message and transmitting the data message to a host machine in the data center).

FIG. 9 illustrates the path of an egress data message (represented by the dashed line) through the multiple stages of logical processing implemented by the gateway MFE 800 and the third-party service machine 805. Upon receipt of the data message, the gateway MFE 800 first applies any logical network processing 825 required before the centralized routing component, such as the transit logical switch (between the distributed routing component and the centralized routing component). In some cases, a tier-1 logical router will also have a centralized routing component implemented on the gateway MFE, in which case the additional logical processing may include this centralized routing component, the distributed routing component of the tier-0 logical router, the transit logical switches between them, etc.

The centralized routing component processing 815 identifies the uplink interface as its output interface, which leads to application of the PBR rules 810. These rules, in this case, also redirect outgoing data messages to the service machine 805, so the gateway MFE 800 applies the centralized routing component processing 815 again and subsequently the service attachment logical switch processing 820, and transmits the data message to the third-party service machine 805. Assuming the data message is not dropped by the service machine 805, the gateway MFE 800 receives the data message via its interface corresponding to the service attachment logical switch. At this point, the centralized routing component processing 815 again identifies the uplink as the output interface for that component, and the gateway MFE transmits the data message to the external physical network router associated with the uplink. As mentioned, the data message is marked with a flag upon being received from the service machine 805 so that the gateway MFE does not apply the PBR rules 810 again in some embodiments.

If the service machine is logically connected to a tier-1 logical router, then in some embodiments the PBR rules are applied (for egress data messages) after the tier-1 logical router processing, and before the tier-0 logical router processing. Upon return from the service machine, the gateway MFE then applies the tier-0 distributed routing component, transit logical switch, and tier-0 centralized routing component. Ingress traffic is handled similarly, with the application of the PBR rules after the tier-0 distributed routing component and prior to application of the tier-1 centralized routing component.

As indicated above, FIGS. 10 and 11 illustrate the connection of a service machine to a centralized routing component using L2 bump-in-the-wire mode. FIG. 10 illustrates the path of an ingress data message (represented by the dashed line) through multiple stages of logical processing implemented by a gateway MFE 1000 and a third-party service machine 1005. In the L2 bump-in-the-wire mode, two interfaces of the logical router are associated with each connection to the service machine 1005. Data messages are transmitted to the service machine via one of the interfaces and returned via the other interface.

As in the example of FIGS. 8 and 9, the gateway MFE 1000 implements PBR redirection rules 1010, centralized routing component processing 1015, and additional logical processing 1030. Because there are two separate interfaces for the connection to the service machine 1005, the gateway MFE 1000 also implements two separate service attachment logical switches 1020 and 1025. In some embodiments, the interface associated with the first logical switch 1020 is an “untrusted” interface, while the interface associated with the second logical switch 1025 is a “trusted” interface. In this figure, each of the centralized routing component service attachment interfaces is associated with a separate interface of the gateway MFE 1000. In other embodiments, however, these service attachment interfaces share one gateway MFE interface.

For the incoming data message in FIG. 10, the gateway MFE 1000 applies the PBR rules 1010 to determine whether to redirect the data message before processing the data message through any of the logical forwarding elements. In some embodiments, the gateway MFE also performs additional operations before applying the PBR rules, such as IPSec and/or other locally-applied services. The PBR rules, described in further detail below, identify whether a given data message will be redirected (e.g., based on various data message header fields, such as the source and/or destination IP addresses), how to redirect the data messages that match specific sets of header field values, etc. In this case, the PBR rules 1010 specify to redirect the data message to the interface of the third-party service machine 805 that is associated with the first logical switch 1020.

Based on this determination, the centralized routing component processing 815 identifies that the redirection interface corresponds to the first service attachment logical switch 1020. Because the service machine 1005 is connected in L2 bump-in-the-wire mode, the centralized routing component uses the MAC address of this interface as the source address for the redirected data message and the MAC address of the other service attachment interface (connected to the second logical switch 1025) as the destination address). This causes the data message to be returned by the service machine 1005 to this second (trusted) interface.

The gateway MFE 1000 then executes the logical switch processing 1020 and, based on this logical switch processing, transmits the data message to the third-party service machine 1005. This service machine 1005 performs its service processing (e.g., firewall, NAT, cloud extension, etc.) and returns the data message to the gateway MFE (unless the service drops/blocks the data message). Upon return of the data message from the service, the gateway MFE identifies the second logical switch 1025 for processing based on the destination address of the data message and/or the gateway MFE interface on which the message is received, then performs the processing for the centralized routing component 1015 (e.g., routing based on the destination network address) and, in turn, the additional logical processing operations 1030. In some embodiments, data messages returning from the third-party service machine are marked with a flag to indicate that the PBR rules do not need to be applied again. Based on these operations, the gateway MFE 800 transmits the data message to its destination in the logical network (e.g., by encapsulating the data message and transmitting the data message to a host machine in the data center).

FIG. 11 illustrates the path of an egress data message (represented by the dashed line) through the multiple stages of logical processing implemented by the gateway MFE 1000 and the third-party service machine 1005, connected in L2 bump-in-the-wire mode. Upon receipt of the data message, the gateway MFE 1000 first applies any logical network processing 1030 required before the centralized routing component, such as the transit logical switch (between the distributed routing component and the centralized routing component). In some cases, a tier-1 logical router will also have a centralized routing component implemented on the gateway MFE, in which case the additional logical processing 1030 may include this centralized routing component, the distributed routing component of the tier-0 logical router, the transit logical switches between them, etc.

The centralized routing component processing 1015 then identifies the uplink interface as its output interface, which leads to application of the PBR rules 1010. These rules, in this case, redirect outgoing data messages to the service machine 805 via the trusted interface attached to the second logical switch 1025. Thus, the gateway MFE 800 applies the centralized routing component processing 1015 again and subsequently the processing for the second service attachment logical switch 1025, and transmits the data message to the third-party service machine 1005. In this direction, the data message has the trusted interface MAC address as its source address and the untrusted interface MAC address as its destination address, traversing the opposite path from the centralized routing component 1015 to the service machine 1005 and back as for an ingress data message.

Assuming the data message is not dropped by the service machine 1005, the gateway MFE 800 receives the data message via its interface corresponding to the first service attachment logical switch 1020. At this point, the centralized routing component processing 1015 again identifies the uplink as the output interface, and the gateway MFE transmits the data message to the external physical network router associated with the uplink. As mentioned, the data message is marked with a flag upon being received from the service machine 1005 so that the gateway MFE does not apply the PBR rules 1010 again in some embodiments.

In some embodiments, the PBR rules use a two-stage lookup to determine whether to redirect a data message (and to which interface to redirect the data message). Specifically, rather than the PBR rules providing the redirection details directly, each rule specifies a unique identifier. Each identifier corresponds to a service machine, and the gateway stores a dynamically-updated data structure for each identifier that provides details about how to redirect data messages.

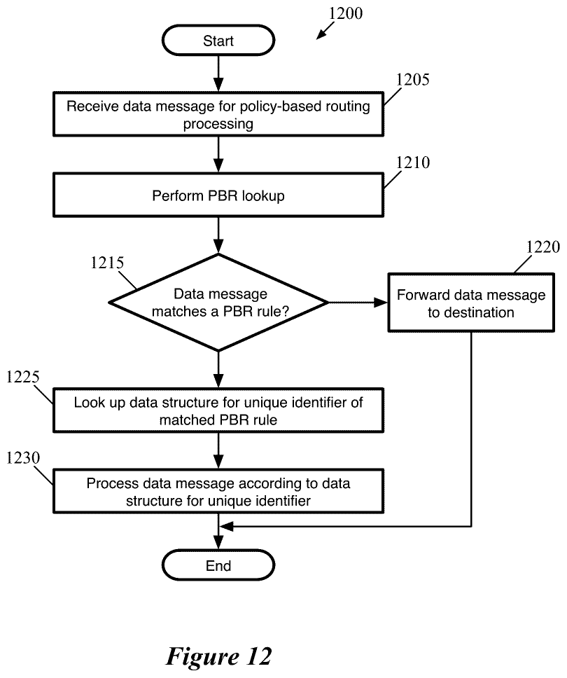

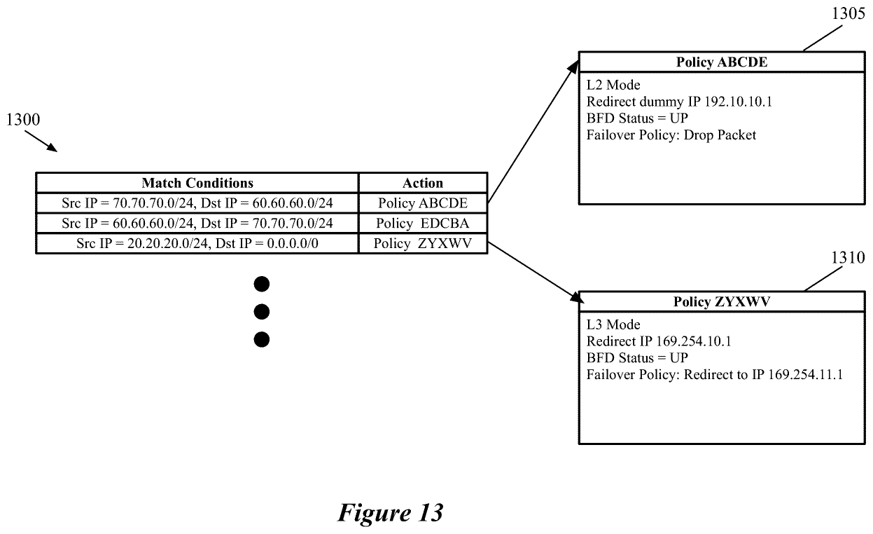

FIG. 12 conceptually illustrates a process 1200 of some embodiments for applying policy-based routing redirection rules to a data message. In some embodiments, the process 300 is performed by a gateway MFE such as those shown in FIGS. 8-11, when applying the PBR rules to either an incoming (from an external network) or outgoing (from the logical network) data message. This process 1200 will be described in part by reference to FIG. 13, which illustrates a set of PBR rules and data structures for some of these rules.

As shown, the process 1200 begins by receiving (at 1205) a data message for PBR processing. This may be a data message received via a logical router uplink from an external network or a data message sent by a logical network endpoint for which the gateway MFE has already identified the uplink as the egress port for the centralized routing component. In some embodiments, the process 1200 is not applied to data messages for which a flag is set indicating that the data message is received from a third-party service machine. These data messages are

The process 1200 then performs (at 1210) a lookup into a set of PBR rules. In some embodiments, these rules are organized as a set of flow entries, with match conditions and actions for data messages that match each set of match conditions. Depending on the context of the gateway datapath, the PBR rules of some embodiments use a hash table (or set of hash tables) using one or more hashes of sets of data message header fields. Other embodiments use other techniques to identify a matching PBR rule.

FIG. 13 illustrates a table of PBR rules 1300. In this case, the rules all match on the source and destination IP addresses, but PBR rules of some embodiments can also match on other header fields (and combinations of other header fields with source and/or destination IP addresses). For example, the first two match conditions are inverses of each other, one for handling ingress data messages (from 70.70.70.0/24 in an external network to the 60.60.60.0/24 subnet in the logical network), and the other for handling the corresponding egress data messages. The third match condition matches on any data message sent from the source subnet 20.20.20.0/24 (i.e., irrespective of the destination address). As described further below, the actions specify unique policy identifiers rather than specific redirection actions.

Returning to FIG. 12, the process 1200 determines (at 1215) whether the data message matches any of the PBR rules based on the PBR lookup. In some embodiments, the PBR rules table includes a default (lowest priority) rule (or set of rules) for data messages that do not match any of the other rules. If the data message does not match any PBR rules (or only matches a default rule), the process forwards (at 1220) the data message to its destination without any redirection. Thus, outgoing data messages are transmitted to the appropriate physical router (after performing any additional IPSec or other local service processing), while incoming data messages begin logical processing at the centralized logical router.

On the other hand, if the data message matches one of the PBR rules, the process looks up (at 1225) a data structure for a unique identifier specified by the matched PBR rule. As shown in FIG. 13, the actions for each of the PBR rules do not directly specify to redirect matching data messages to a particular next hop address. Instead, these actions specify unique policy identifiers, which in turn map to corresponding dynamically-updated data structures. That is, the gateway MFE is configured to store a data structure for each unique identifier specified in a PBR action. These data structures may be database table entries or any other type of modifiable data structure. In some embodiments, the gateway MFE is configured to some or all fields of the data structures based on, e.g., current network conditions.

These data structures, in some embodiments, indicate the type of connection to the service (e.g., L2 bump-in-the-wire or L3 one-arm), a network address for the interface of the service to which the data message is redirected, dynamically-updated status data, and a failover policy. The status data is dynamically updated based on the health/reachability of the service, which may be tested using a heartbeat protocol such as bidirectional forwarding detection (BFD). The failover policy, in some embodiments, specifies what to do with the data message if the service is not reachable.

FIG. 13 illustrates the contents of two of these data structures. The data structure 1305, for unique identifier ABCDE, indicates that the service machine to which this policy redirects is connected in L2 bump-in-the-wire mode (such that opposite direction data messages that match the second PBR rule would be redirected to the same service machine in the opposite direction). The data structure 1305 also indicates a dummy IP address to use for redirection. This dummy IP is not actually the address of the service machine, but instead resolves to the MAC address of the service attachment interface of the centralized routing component via which the data message will return (e.g., for ingress data messages, the trusted interface of the centralized routing component). This address resolution may be performed with statically configured ARP entries in some embodiments.

In addition, the data structure 1305 specifies the current BFD status of the connection to the service machine (the connection is currently up) as well as a failover policy indicating how to handle the data message if the BFD status is down. It should be noted that while these examples use BFD, other mechanisms for monitoring the reachability of the service machine may be used as well (e.g., other heartbeat protocols, other measures of connection status, etc.). In this case, the failover policy indicates that data messages should be dropped if the service machine is not available. Other failover policy options may include, e.g. forwarding the data message to its destination without redirection to the service, redirection to a backup service machine, etc.

The data structure 1310, for unique identifier ZYXWV, indicates that the service machine to which this policy redirects is connected in L3 one-arm mode, and thus the redirection IP address provides the address of the service machine interface (rather than a dummy IP). The BFD status of this connection is also up, but in this case the failover policy provides for redirection to a backup service machine at a different IP address on a different subnet (i.e., connected to a different logical switch).

Returning to FIG. 12, the process 1200 processes (at 1230) the data message according to the instructions in the data structure for the unique identifier. This may include redirecting the data message to the next hop IP address specified by the data structure, dropping the data message if the connection is down and the failure policy specifies to drop the data message, or forwarding the data message according to the logical network processing if the connection is down and the failure policy specifies to ignore the redirection.

As noted, the data structures for each redirection policy are updated dynamically by the gateway MFE. In some embodiments, a BFD thread executes on the gateway machine to (i) send BFD messages to the service machine and (ii) receive BFD messages from the service machine. For service machines connected in L3 one-arm mode, the service machines also execute a BFD thread that sends BFD messages to the gateway. On the other hand, in L2 bump-in-the-wire mode, the BFD thread sends BFD messages out one of the interfaces connecting the centralized routing component to the service machine and receives these messages back on the other interface. Some such embodiments send the BFD messages out through both interfaces (with BFD messages sent from the trusted interface received at the untrusted interface, and vice versa). This process is described in greater detail in U.S. patent application Ser. No. 15/937,615, which is incorporated herein by reference. In some embodiments, one BFD thread executes on each gateway MFE and exchanges messages with all of the connected service machines, while in other embodiments separate BFD threads execute on a gateway MFE to exchange messages with each connected service machine. When the BFD thread detects that BFD messages are no longer being received from a particular service machine, the gateway MFE modifies the data structure for that service machine.

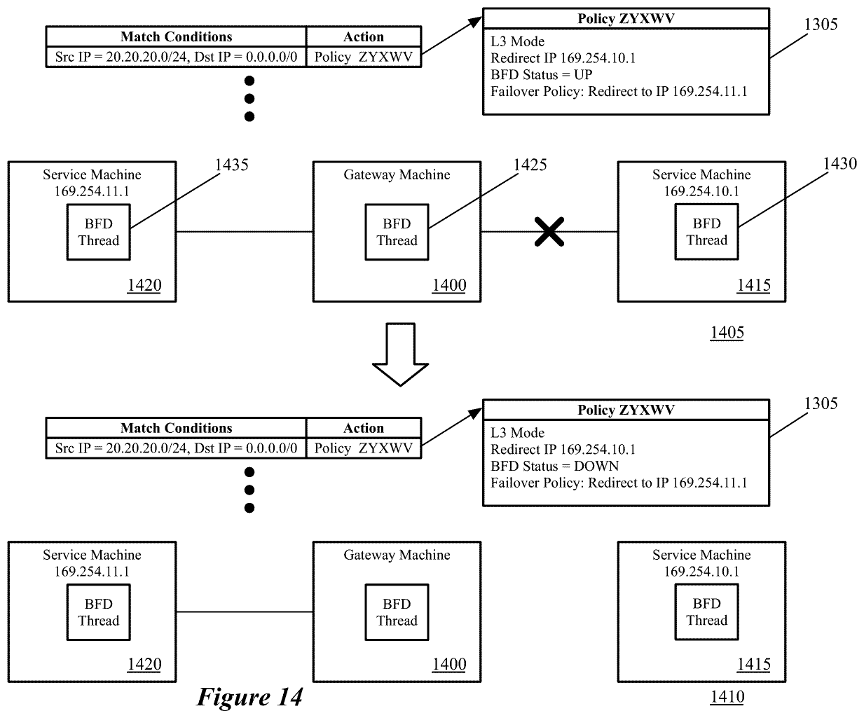

FIG. 14 conceptually illustrates the data structure 1310 being dynamically updated based on a change in the connection status of the service machine to which the data structure redirects data messages. This figure illustrates both the data structure 1310 as well as connections between the gateway machine 1400 and two service machines 1415 and 1420 over two stages 1405 and 1410.

In the first stage 1405, the data structure 1310 is in the same state as in FIG. 13, indicating that the connection to the service machine endpoint interface 169.254.10.1 is currently up as per the BFD status. The gateway machine 1400, in addition to operating the gateway MFE with its logical network processing, PBR rules, etc. also executes a BFD thread 1425. This BFD thread 1425 sends BFD messages to both the first service machine 1415 at its interface with IP address 169.254.10.1 and the second service machine 1420 at its interface with IP address 169.254.11.1 at regular intervals. In addition, each of these service machines 1415 and 1420 execute their own BFD threads 1430 and 1435, respectively, which send BFD messages to the gateway machine at regular intervals. As shown by the large X, at this stage 1405 the connection between the gateway machine 1400 and the first service machine 1415 goes down. This could occur due to a physical connection issue, an issue with the service machine 1415 crashing, etc. As a result, the BFD thread 1425 would no longer receive BFD messages from the service machine 1415.

In the second stage 1410, the connection between the gateway machine 1400 and the service machine 1415 is no longer present. In addition, the data structure 1305 has been dynamically updated by the gateway MFE to indicate that the BFD status is down. As a result of the failover policy specified by this data structure 1305, data messages with a source IP in the subnet 20.20.20.0/24 would be redirected to the 169.254.11.1 interface of the second service machine 1420 until the connection to the first service machine 1415 comes back up.

In some embodiments, multiple threads can write to the data structures 1305 and 1310. For instance, some embodiments allow the BFD thread as well as a configuration receiver thread to both write to these data structures (e.g., to modify the BFD status as well as to make any configuration changes received from the network control system). In addition, one or more packet processing threads are able to read these data structures for performing packet lookups. Some embodiments enable these packet processing threads to read from the data structures even if one of the writer threads is currently accessing the structures, so that packet processing is not interrupted by the writer threads.

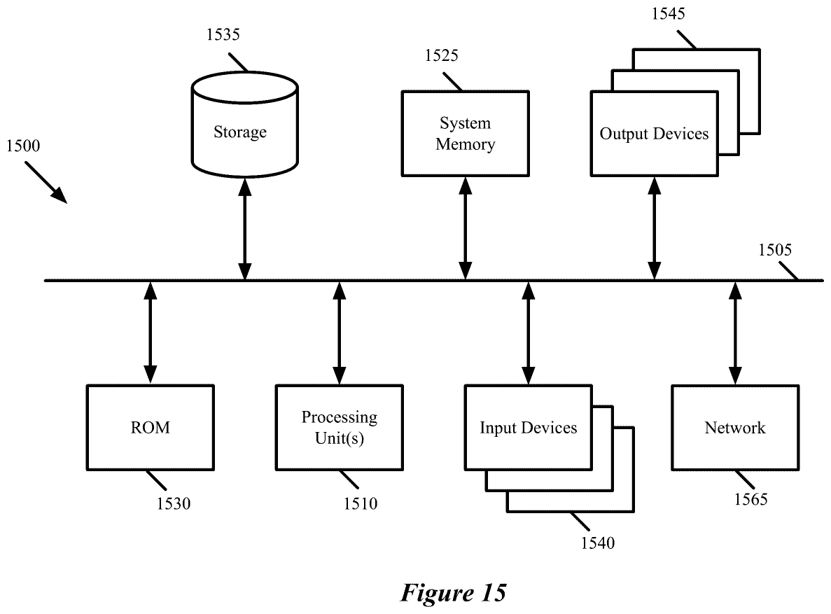

FIG. 15 conceptually illustrates an electronic system 1500 with which some embodiments of the invention are implemented. The electronic system 1500 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 1500 includes a bus 1505, processing unit(s) 1510, a system memory 1525, a read-only memory 1530, a permanent storage device 1535, input devices 1540, and output devices 1545.

The bus 1505 collectively represents all system, peripheral, and chipset buses that communicatively connect the numerous internal devices of the electronic system 1500. For instance, the bus 1505 communicatively connects the processing unit(s) 1510 with the read-only memory 1530, the system memory 1525, and the permanent storage device 1535.

From these various memory units, the processing unit(s) 1510 retrieve instructions to execute and data to process in order to execute the processes of the invention. The processing unit(s) may be a single processor or a multi-core processor in different embodiments.

The read-only-memory (ROM) 1530 stores static data and instructions that are needed by the processing unit(s) 1510 and other modules of the electronic system. The permanent storage device 1535, on the other hand, is a read-and-write memory device. This device is a non-volatile memory unit that stores instructions and data even when the electronic system 1500 is off. Some embodiments of the invention use a mass-storage device (such as a magnetic or optical disk and its corresponding disk drive) as the permanent storage device 1535.

Other embodiments use a removable storage device (such as a floppy disk, flash drive, etc.) as the permanent storage device. Like the permanent storage device 1535, the system memory 1525 is a read-and-write memory device. However, unlike storage device 1535, the system memory is a volatile read-and-write memory, such a random-access memory. The system memory stores some of the instructions and data that the processor needs at runtime. In some embodiments, the invention's processes are stored in the system memory 1525, the permanent storage device 1535, and/or the read-only memory 1530. From these various memory units, the processing unit(s) 1510 retrieve instructions to execute and data to process in order to execute the processes of some embodiments.

The bus 1505 also connects to the input and output devices 1540 and 1545. The input devices enable the user to communicate information and select commands to the electronic system. The input devices 1540 include alphanumeric keyboards and pointing devices (also called “cursor control devices”). The output devices 1545 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 15, bus 1505 also couples electronic system 1500 to a network 1565 through a network adapter (not shown). In this manner, the computer can be a part of a network of computers (such as a local area network (“LAN”), a wide area network (“WAN”), or an Intranet, or a network of networks, such as the Internet. Any or all components of electronic system 1500 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIGS. 10 and 12) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

What is claimed is:

1. A method comprising:
receiving a data message via a logical router from an external network;
performing a lookup into routing rules;
determining a matching between the routing rules and conditions and actions of the data message;
providing a data structure for a unique identifier based on the matching, the data structure comprises an instruction;
processing the data according to the instruction; and
forwarding, using a router and through a physical network, the data message according to the instruction.

2. The method of claim 1, wherein the routing rules comprise policy-based routing rules.

3. The method of claim 1, wherein the data structure indicates a connection type and a service machine.

4. The method of claim 1, wherein the data structure comprises a dummy address to use for redirection.

5. The method of claim 1, wherein the data structure comprises a status of a connection associated with a service machine.

6. The method of claim 1, wherein the instruction comprises redirection information.

7. The method of claim 1, wherein a set of header fields of the data message is mapped to the unique identifier corresponding to a service that performs non-forwarding processing on data messages.

8. The method of claim 1, further comprising updating the data structure to retrieve instructions for forwarding the data message.

9. The method of claim 1, further comprising storing the data structure at a forwarding element.

10. The method of claim 1, further comprising forwarding the data message to destination without redirection.

11. A non-transitory machine readable medium storing a program, the program comprising sets of instructions for:
receiving a data message via a logical router from an external network;
performing a lookup into routing rules;
determining a matching between the routing rules and conditions and actions of the data message;
providing a data structure for a unique identifier based on the matching, the data structure comprises an instruction;
processing the data according to the instruction; and
forwarding, using a router and through a physical network, the data message according to the instruction.

12. The non-transitory machine readable medium of claim 11, wherein the routing rules comprise policy-based routing rules.

13. The non-transitory machine readable medium of claim 11, wherein the data structure indicates a connection type and a service machine.

14. The non-transitory machine readable medium of claim 11, wherein the data structure comprises a dummy address to use for redirection.

15. The non-transitory machine readable medium of claim 11, wherein the data structure comprises a status of a connection associated with a service machine.

16. The non-transitory machine readable medium of claim 11, wherein the instruction comprises redirection information.

17. The non-transitory machine readable medium of claim 11, wherein a set of header fields of the data message is mapped to the unique identifier corresponding to a service that performs non-forwarding processing on data messages.

18. The non-transitory machine readable medium of claim 11, wherein the program further comprising sets of instructions for updating the data structure to retrieve instructions for forwarding the data message.

19. The non-transitory machine readable medium of claim 11, wherein the program further comprising sets of instructions for storing the data structure at a forwarding element.

20. The non-transitory machine readable medium of claim 11, wherein the program further comprising sets of instructions for forwarding the data message to destination without redirection.
